(19) United States
(12) Patent Application Publication
(10) Pub. No.: US 2008/0102936 A1
(43) Pub. Date: May 1, 2008

(54) Game machine, game system and game control method

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/723,256

(22) Filed: Mar. 19, 2007

Related U.S. Application Data
(60) Provisional application No. 60/854,067, filed on Oct. 25, 2006.

(51) Int. Cl. A63F 5/04; G07F 17/34

(52) U.S. Cl. 463/25

(57) ABSTRACT

In a game machine, a game system, and a game control method according to the present invention, it is made possible to select a game using base game software when points awarded according to a past game execution amount is not more than a preset threshold value. It is made possible to select specific game software on which a higher bet can be bet than that bet on the base game software, in addition to the game using the base game software, when the points are more than the preset threshold value. Therefore, a higher frequent player of the game machine can execute a game capable of higher bet.

### CROSS-REFERENCE TO RELATED APPLICATION

This application is based upon and claims the benefit of U.S. Provisional Patent Application Ser. No. 60/854,067, filed on Oct. 25, 2006; the entire contents of which are incorporated herein by reference for all purposes.

### BACKGROUND OF THE INVENTION

1. Field of the Invention

The present invention relates to a game machine, a game system and a game control method.

2. Description of Related Art

U.S. Pat. No. 6,645,077, US patent application publication No. 2005/0054448 and US patent application publication No. 2006/0035713 disclose gaming systems which use download technique of game programs via a network. In the gaming system, multiple types of games can be executed in a single gaming machine, and game contents executable on the gaming machine in the network can be changed.

In the above gaming system, game software is downloaded from a server to each of gaming machines, and the downloaded game software is executed on each gaming machine so that the game is played.

Therefore, such a gaming system is demanded that has new entertainment characteristics which can provide a gaming environment preferred by players.

### SUMMARY OF THE INVENTION

A game machine of a first present invention comprises, a first memory for storing player's gaming history data including points awarded according to a past game execution amount; a second memory for storing game software downloaded from a server storing multiple types of game software; a player data reader for identifying a player; and a controller. The controller is operable to (a) based on the gaming history data of the player identified by the player data reader, (i) make only base game software selectable for the player, when the points are not more than a preset threshold value, and (ii) make specific game software on which a higher bet can be bet than that bet on the base game software selectable for the player, in addition to the base game software, when the points are more than the threshold value, (b) download from the server game software selected by an external input by the player among selectable game software to store it in the second memory, and (c) execute a game of the game software stored in the second memory.

A game machine of a second present invention comprising a card slot into which a card storing player's gaming history data can be inserted (the gaming history data includes points awarded according to a past game execution amount and player's authenticating data); a first memory for storing the gaming history data read from the card inserted into the card slot; a second memory for storing game software downloaded from a server storing multiple types of game software; a selection switch for selecting any game software from among the multiple types of game software; a display for displaying an image relating to execution of the game software selected by the selection switch; and a controller. The controller is operable to (a) based on the gaming history data of the player stored in the first memory, (i) make only base game software selectable for the player, when the points are not more than a preset threshold value, and (ii) make specific game software on which a higher bet can be bet than that bet on the base game software selectable for the player, in addition to the base game software, when the points are more than the threshold value, (b) download from the server game software selected by the player using the selection switch among selectable game software to store it in the second memory, and (c) execute a game of the game software stored in the second memory.

A game machine of the third present invention comprises a card slot into which a card storing player's gaming history data can be inserted (the gaming history data including points awarded according to a past game execution amount and player's authenticating data); a first memory for storing the gaming history data read from the card inserted into the card slot; a second memory for storing game software downloaded via a network interface from a server storing multiple types of game software; a selection switch for selecting any game software from among the multiple types of game software; a display for displaying an image relating to execution of the game software selected by the selection switch; and a controller. The controller is operable to (a) set predetermined game software as default game software to make it executable, (b) based on the gaming history data of the player stored in the first memory, (i) make base game software other than the default game software selectable for the player, when the points are not more than a preset threshold value, and (ii) make specific game software on which a higher bet can be bet than that bet on the base game software selectable for the player, in addition to the base game software, when the points are more than the threshold value, (c) download from the server game software selected by the player using the selection switch among selectable game software to store it in the second memory, and (d) execute a game of the game software stored in the second memory. The controller is operable to subtract a predetermined number of the points from the gaming history data, when the specific game software or the base game software other than the default game software is selected.

A game system of the fourth present invention comprises at least one game machine and a server. The game machine comprises a first memory which can store player's gaming history data including points awarded according to a game execution amount in the past; a network interface for executing communication; a second memory for storing game software downloaded from the server storing multiple types of game software; a player data reader for identifying a player; and a controller. The controller is operable to (a) based on the gaming history data for the player identified by the player data reader, (i) make only base game software selectable for the player, when the points are not more than a preset threshold value, and (ii) make specific game software on which a higher bet can be bet than that bet on the base game software selectable for the player, in addition to the base game software, when the points are more than the threshold value, (b) send to the server via the network interface a request signal of requesting to send game software selected by an external input by the player among selectable game software, (c) download the game software received according to the request signal to store it in the second memory, and (d) execute a game of the game software stored in the second memory. The server is connected with the game machine via a network, comprises a third memory storing multiple types of the game software and sends the game software according to the request signal to the game machine when receiving the request signal via the network.

A game control method of the fifth present invention comprising the following steps of (a) identifying a player and recognizing the player's gaming history data which includes points awarded according to the past game execution amount; (b) making only base game software selectable for the player among multiple types of game software stored in a server, when the points are not more than a preset threshold value and making specific game software on which a higher bet can be bet than that bet on the base game software selectable for the player, in addition to the base game software, when the points are more than the threshold value, based on the gaming history data of the player; and (c) downloading from the server game software selected by an external input by the player among selectable game software to store it and executing a game of the game software.

A game control method of the sixth present invention comprising the following steps of (a) recognizing player's gaming history data which includes points awarded according to the past game execution amount based on a card carried by the player; (b) making only base game software selectable for the player among multiple types of game software stored in a server, when the points are not more than a preset threshold value and making specific game software on which a higher bet can be bet than that bet on the base game software selectable for the player, in addition to the base game software, when the points are more than the threshold value, based on the gaming history data of the player; (c) accepting a selection input of the game software by the player using a selection switch; and (d) downloading from the server via a network interface the game software based on the selection input to store it and executing a game of the game software.

A game control method of the seventh present invention comprising the following steps of (a) recognizing player's gaming history data stored in a card carried by the player when the card is inserted into a card slot (the gaming history data includes points awarded according to a past game execution amount and player's authenticating data); (b) making predetermined game software set as default game software executable; (c) making base game software other than the default game software selectable for the player, when the points are not more than a preset threshold value and making specific game software on which a higher bet can be bet than that bet on the base game software selectable for the player, in addition to the base game software, when the points are more than the threshold value, based on the gaming history data; (d) accepting a selection input of the game software by the player using a selection switch; (e) downloading from the server via a network interface the game software based on the selection input to store it and executing a game of the game software; and (f) subtracting a predetermined number of the points from the gaming history data when the specific game software or the base game software other than the default game software is selected by the selection input.

The gaming machine is not particularly limited. The gaming machines may include gaming machines such as slot machine, personal computers, and personal digital assistants, for example. Games to be played in the gaming machine are not particularly limited. The games may include video bingo games, video lottery games, video blackjack games, video slot games, mechanical slot games, video poker games, video keno games, video pachinko games, video card games, and video games of chance.

Hardware configuration of the server is not particularly limited provided that it functions as the server of the present invention. As the server, a general-purpose server may be employed. In addition, the server may include a firewall and a modem. The server may comprise a single device or multiple devices. Any of the gaming machines having a firewall and a modem may be configured to function as the server.

The network interface is not particularly limited provided that it can communicate with the server and, thus, the network interface may be any of a wireless network interface and a wired network interface. In addition, communication between the server and the plurality of game machines may be executed via the Internet or an intranet. The intranet is not particularly limited and, thus, a cashless system network, a progressive game network, an accounting network, a bonus game network, and the like, may be used. The first memory is not particularly limited and, thus, nonvolatile memory, a hard disk drive, a CD-RW drive, a DVD-RAM drive, and the like, maybe included as the first memory. The same applies to the second memory.

The card may store an ID code. In addition, only the ID code may be stored in the card and the gaming history data corresponding to the ID code may be stored in the server. Still further, the controller may obtain the gaming history data corresponding to the input of the biological information such as finger print, vein or the like.

The points may be awarded in accordance with the gaming media paid out or number of times of the game executed. The points may be stored in the card or may be stored in a third memory provided for the server or may be stored in both thereof.

Additionally, the controller may execute a game using only game software components downloaded from the server. Also, the controller may execute a game using the game software components downloaded from the server in combination with the game software components preliminarily stored in the second memory.

With the game system, the following game processing data may be generated in respective game machines, sent to the server and stored in the first memory. The game processing data may include, for example, game version data, game data, game machine data, player data, route data, venue data or the like. The player data may include gaming media consumed or number of times of the game played, or points awarded during the game. The game processing data may be stored in the third memory as a database being partitioned from the game software components.

### BRIEF DESCRIPTION OF THE DRAWINGS

FIG. 1 is a flow chart schematically illustrating a processing procedure of a game control method according to the present invention.

FIG. 2 is a schematic view of a network of a game system according to one embodiment of the present invention.

FIG. 3 is a block diagram illustrating the internal configuration of the server according to the one embodiment of the present invention.

FIG. 4 is a perspective view illustrating an appearance of a slot machine (game machine) according to the one embodiment of the present invention.

FIG. 5 is a block diagram illustrating the internal configuration of the slot machine shown in FIG. 4.

FIG. 6 is a first section of a flowchart illustrating a processing executed at the server and the slot machine according to the one embodiment of the present invention.

FIG. 7 is a second section of a flowchart illustrating a processing executed at the server and the slot machine according to the one embodiment of the present invention.

FIG. 8 is a third section of a flowchart illustrating a processing executed at the server and the slot machine according to the one embodiment of the present invention.

FIG. 9 is an explanatory diagram illustrating an image displayed on a lower display of the slot machine according to the one embodiment of the present invention.

FIG. 10 is a flow chart illustrating a game execution processing.

FIG. 11 is a diagram illustrating an image displayed on a lower display of the slot machine according to the one embodiment of the present invention.

FIG. 12 is a schematic view of a network of a game system according to another embodiment of the present invention.

### DETAILED DESCRIPTION OF THE EMBODIMENT

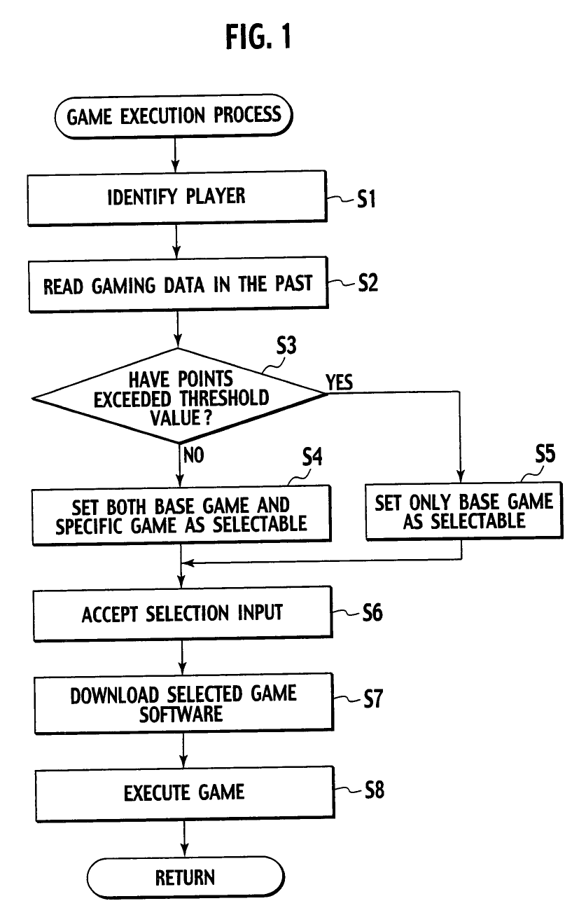

FIG. 1 is a flow chart schematically illustrating a playing method of a slot machine according to the present invention. An overall operation of a game machine according to the present invention will be described based on this flow chart. As game machines, for example, slot machines may be cited. When a game is played in the slot machine, a smart card carried by a player is firstly read, and a process of identifying the player is executed (step S1). Further, points awarded at past games played by the player are also read by reading the smart card (step S2).

The points are awarded according to a game execution amount of past games played by the player. Here, the game execution amount denotes the number of credits consumed by the player in a game machine or the number of times of games played by the player. For example, if 100 coins have been consumed or if 100 times of games have been played, one point is awarded.

Then the game machine determines whether or not the points are more than a preset threshold value (step S3). Then, if it is determined that they are not more than the threshold value, only a game using base game software becomes selectable (step S4). On the game using the base game software, a high bet can not be bet. Alternatively, if it is determined that they are more than the preset threshold value, a game using specific game software becomes selectable, in addition to the game using the base game software (step S5). On the game using specific game software, a high bet can be bet. The threshold value can be changed as appropriate by an operation of a system administrator who is authorized to operate.

Thereafter, the game machine accepts a selection input of game software by the player (step S6). In this process, the player can select a desired game from among multiple types of games displayed on a screen.

The game machine downloads game software of the game selected by the player from a server (step S7), and executes the game using the downloaded game software (step S8).

With this configuration, the player can select the desired game, and the player who played games many times in the past can select the specific game software on which a high bet can be bet.

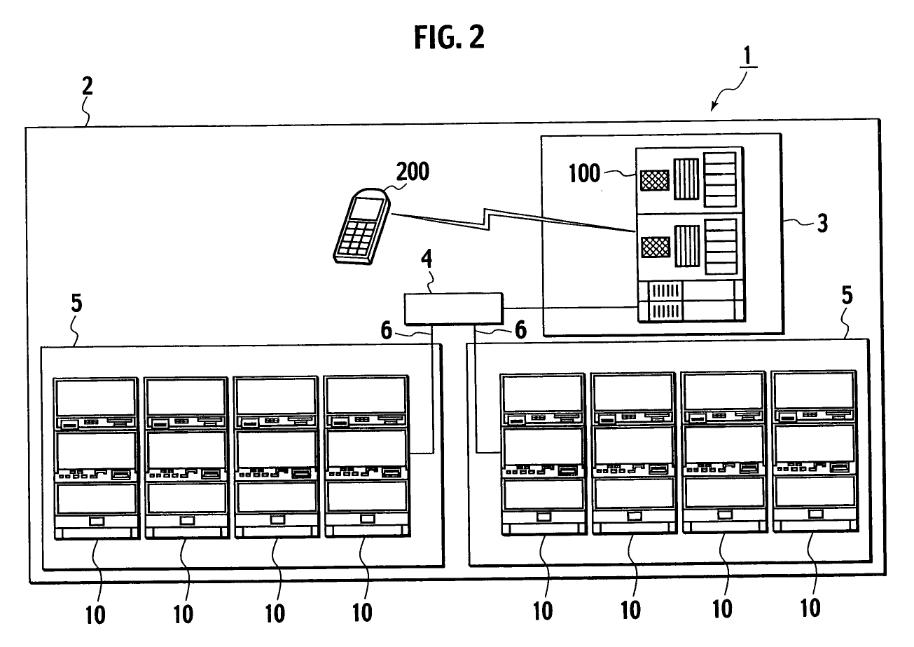

FIG. 2 is a configuration diagram schematically illustrating a game system according to one embodiment of the present invention. A game system 1 shown in FIG. 2 includes a server 100 and a plurality of slot machines (game machines) 10 installed in a casino 2.

The server 100 is installed in a computer room 3 within the casino 2. The plurality of slot machines 10 are installed on a casino floor 5. The server 100 and the plurality of slot machines 10 are connected by a LAN 6 through a router 4. A remote controller 200 is carried by a shop attendant in the casino 2. The remote controller 200 is capable of wireless communication with the server 100. Therefore, the shop attendant can communicate with the server 100 using the remote controller 200 in the computer room 3 or casino floor 5.

The server 100 has a management tool for managing information relating to each group of slot machines 10 and a user's access to the server 100, and a download tool and the like. An operator of the server 100 who has appropriate access right can change setting of various programs such as game software.

The slot machine 10 corresponds to the game machine in the present invention. In the present invention, however, the game machine, not limited to this example, may be a video slot machine, a mechanical slot machine, or a game machine capable of executing bingo games, keno games, lottery games, and the like.

The slot machine 10 is installed on the casino floor 5. In the present invention, however, a place where the game machines are installed is not particularly limited and may be a casino, a store, a restaurant, a bar, a ship, and the like. In addition, the installation place for the game machines may be owned or operated by a plurality of administrators. In addition, the game system of the present invention may comprise multiple types of different installation places.

Each slot machine 10 sends game processing information (e.g., number of inserted coins, number of payouts), game software information (e.g., software version information), player information (e.g., ID code of the player) to the server 100. In addition, each slot machine 10, capable of transmitting and receiving information to and from the server 100, communicates with the server 100 through the router 4.

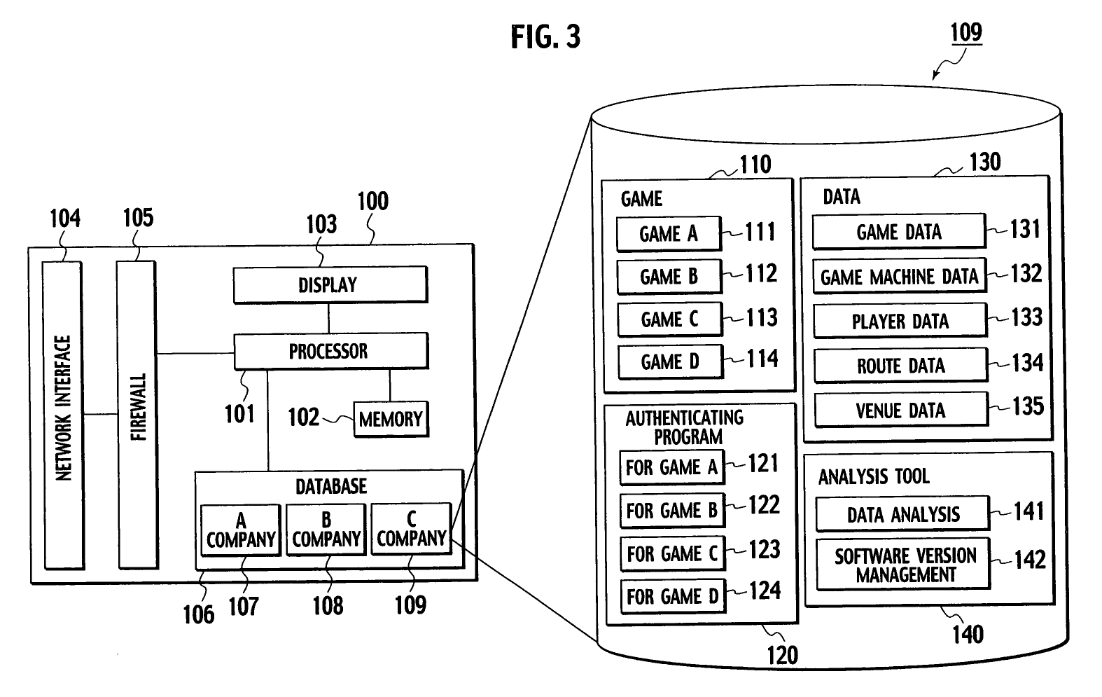

FIG. 3 is a block diagram illustrating the internal configuration of the server according to one embodiment of the present invention. The server 100 is provided with a processor 101. A memory 102, a database 106 and a display 103 are connected to the processor 101. Furthermore, a network interface 104 is connected to the processor 101 through a firewall 105. The server 100 can communicate with the slot machines (game machines) 10 and a remote controller 200 through the network interface 104. The memory 102 corresponds to the third memory in the game system of the present invention.

The network interface 104 may be a wired or wireless network interface, or may include both. The server 100 is provided with the firewall 105, which blocks unauthorized access to programs in the server 100.

The database 106 is stored on a hard disk drive. For example, various game information such as game processing information, game software, and game software information are stored in the database 106. In the present embodiment, data within the database 106 is partitioned according to respective sectionalized items such as “company A” 107, “company B” 108, and “company C” 109.

In the present invention, the number of partitions is not particularly limited and can be changed as appropriate. In addition, the database 106 may be stored on a known storage medium such as a hard disk drive or a CD-RW drive, for example, or combination thereof.

Data for respective sectionalized items within the database 106 is described, using the data of “company C” 109 as an example. As shown in FIG. 3, the data of “company C” 109 includes a game 110, an authenticating program 120, data 130, and an analysis tool 140.

The game 110 includes the game software for game A 111, game B 112, game C 113, and game D 114. Each game software includes game system program, payout tables, bonus execution programs, game execution program, graphical data, image display control data, sound data, light emission pattern data, game jurisdiction information, or the like.

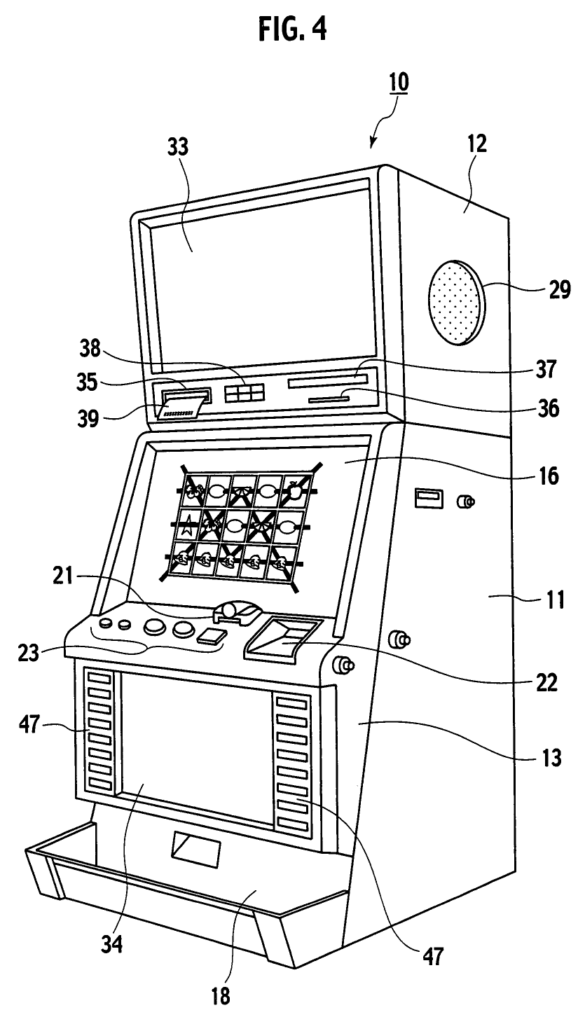

The game system program of the game software used in the slot machine 10 includes, for example, a symbol selection program. The symbol selection program determines the symbols to be rearranged as a symbol matrix on a liquid crystal panel of a lower display 16 (see FIG. 4). The symbol selection program includes symbol weighting data which corresponds to each of the multiple types of payout rates (e.g., 80%, 84% and 88%).

The symbol weighting data indicates the correspondence between respective symbols and one or more random number values within a predetermined numerical range (0-255). The payout rate is determined based on setting information determining a redemption rate to the player in the game. Symbols to be rearranged as a symbol matrix are determined based on the symbol weighting data corresponding to the payout rate.

The authenticating program 120 includes a program 121 for game A, a program 122 for game B, a program 123 for game C, and a program 124 for game D. The authenticating program is created for respective game software. The authenticating program includes a hash value generated from legitimate game software and a program which generates a hash value using a hash function from the game software to be authenticated.

The hash function is not particularly limited and SHA (SHA-1, SHA-256, SHA-384 and SHA-512), MD5 or the like may be employed. In the present embodiment, a program which determines the presence of falsification using a hash function will be described as the authenticating program. However, In the present invention, the authenticating program is not particularly limited and any known authenticating programs may be employed.

The data 130 includes game data 131, game machine data 132, player data 133, route data 134 and venue data 135.

The game data 131 includes, for example, number of inserted coins, number of paid-out coins, number of bets per game, or the like. The game machine data 132 includes, for example, the playing history for each slot machine 10. This data is stored in association with the ID code of each slot machine 10. The player data 133 includes data relating to the gaming history for each player (gaming history data). This data is stored in association with the ID code of each player. The route data 134 includes, for example, connection information between gaming machines at a plurality of installation places. The venue data 135 includes, for example, information on the gaming machines belonging to each installation place.

The analysis tool 140 includes applications for data analysis 141 for setting category of data 130 and relationship between respective categories, and applications for software version management 142 for managing the version of the game software in respective game machines and version of game software to be downloaded. The processor 101 can manage and analyze the data 109 of the sectionalized item “company C” by executing these applications.

FIG. 4 is a perspective view illustrating an appearance of the slot machine 10 according to one embodiment of the present invention. The slot machine 10 includes a cabinet 11, a top box 12 provided on top of the cabinet 11, and a main door 13 provided on the front face of the cabinet 11. A lower display 16 is provided on the front face of the main door 13. The lower display 16 has a liquid crystal panel, on which the symbol matrix composed of 5 columns by 3 rows, totaling in 15 symbols, is displayed. The lower display 16 corresponds to the display in the present invention.

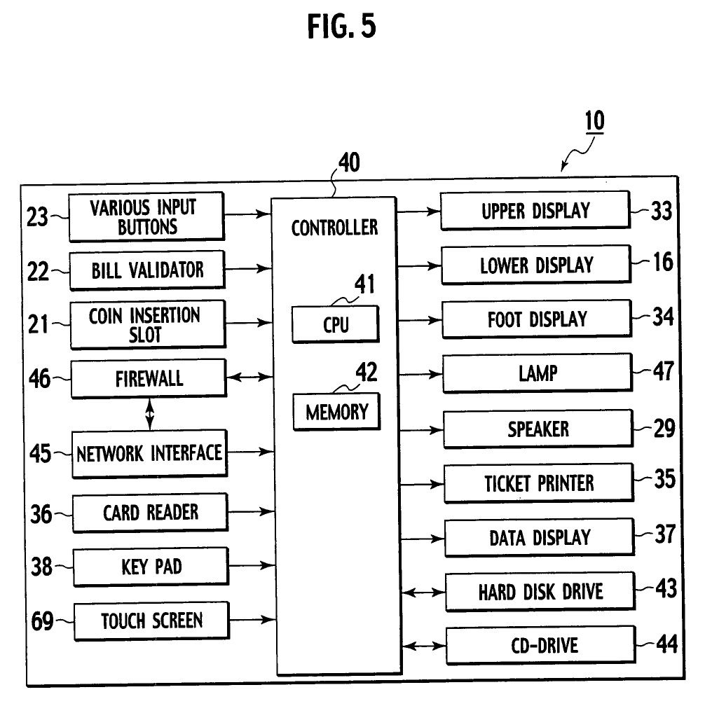

Furthermore, a touch screen 69 (see FIG. 5) is provided on the front face of the lower display 16. The player can input various instructions via the touch screen 69. Additionally, below the lower display 16, various input buttons 23 for inputting the player's instructions relating to the progress of the game, a coin insertion slot 21 for accepting coins, and a bill validator 22 for identifying the validity of bills and accepting legitimate bills are provided. The bill validator 22 can read a barcode ticket 39.

On the front face at a lower part of the main door 13, a foot display 34 is provided. The foot display 34 displays predetermined images based on image display control data included in the game software being executed. As such images, for example, characters of the slot machine 10 and the like are included.

On both sides of the foot display 34, lamps 47 are provided. The lamp 47 emits light in a pattern according to the light emission pattern data included in the game software being executed.

On the front face of the top box 12, an upper display 33 is provided. The upper display 33 has a liquid crystal panel. The upper display 33 displays a payout table and the like.

In addition, a speaker 29 is provided in the top box 12. Below the upper display 33, a ticket printer 35, a card reader 36, a data display 37 and a keypad 38 are provided. The ticket printer 35 prints and outputs a barcode ticket 39. The coded data on the barcode ticket 39 includes the number of credits, date, and an identification number of the slot machine 10 and so on. The player can use the barcode ticket 39 at another slot machine to play a game and exchange it with bills or the like at a predetermined spot in a gaming facility (cashier in a casino, for example).

The card reader 36 can have a smart card inserted therein, and read data from or write data into the inserted smart card. The smart card is carried by the player, which stores data for identifying the player, data relating to the history of the games (gaming history data). The gaming history data includes game type information relating to games which have been played, or points awarded at games played in the past and the like. The card reader 36 corresponds to the player data reader in the present invention.

The smart card may have data corresponding to coins, bills or credits stored therein. Additionally, a magnetic stripe card may be employed in place of the smart card. The data display 37, comprising a fluorescent display or the like, displays data being read by the card reader 36, or data input by the player via the key pad 38, for example. Below the foot display 34 is provided a coin payout opening 18.

Further, in place of the smart card, a card employing RFID system and capable of data read and write in non-contact manner may be used. The key pad 38 is used for inputting instructions and data relating to issuance of tickets or the like. The smart card corresponds to the card of the present invention.

FIG. 5 is a block diagram illustrating the internal configuration of the slot machine shown in FIG. 4. The slot machine 10 is provided with a controller 40 including a CPU 41 and a memory 42. Various input buttons 23, the bill validator 22 and the coin insertion slot 21 are connected to the controller 40. Also, a network interface 45 is connected to the controller 40 through a firewall 46. Furthermore, a card reader 36, the key pad 38 and the touch screen 69 are connected to the controller 40.

In addition, the upper display 33, the lower display 16, the foot display 34, the lamp 47, the speaker 29, the ticket printer 35, the data display 37, a hard disk drive 43 and a CD-drive 44 are connected to the controller 40. The game software downloaded from the server 100 is stored in the hard disk drive 43 or the like.

The controller 40 executes, for example, various programs included in the game software stored in the hard disk drive 43 or the like. The controller 40 executes, for example, the processes of displaying images on the upper display 33, the lower display 16 and the foot display 34, the process of outputting sound from the speaker 29 and the process of controlling light emission of the lamp 47.

The hard disk drive 43 corresponds to the first memory in the present invention. In addition, the hard disk drive 43 corresponds to the second memory in the present invention. Although the present embodiment describes the case where the first and the second memories are the same (i.e., both are the hard disk drive 43), the first and second memories may be separate in the present invention. The controller 40 corresponds to the controller in the present invention.

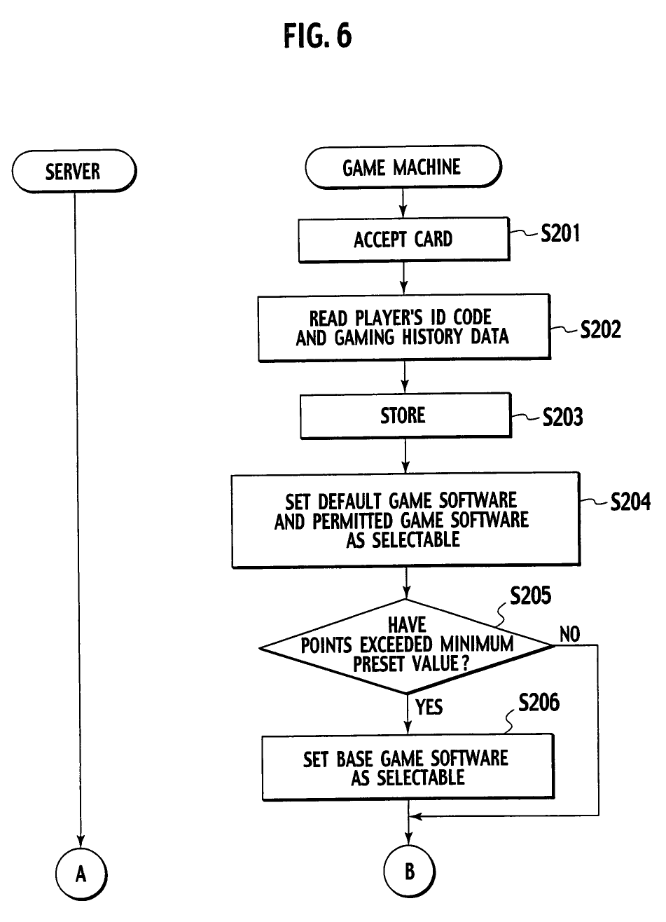

FIGS. 6 to 8 are flow charts illustrating the processing procedures executed between the server 100 and the slot machine 10 according to one embodiment of the present invention. In the present embodiment, the case is described in which game software relating to execution of game A 111 shown in FIG. 3 is preliminarily stored in the hard disk drive 43 as a default setting.

First, the controller 40 of the slot machine 10 (game machine) accepts insertion of the smart card (step S201). When the player inserts the smart card into the card reader 36, the controller 40 reads the player's ID code and the gaming history data relating to past games played by the player stored in the smart card (step S202). Then The player's ID code and the gaming history data are stored in the hard disk drive 43 (step S203).

The gaming history data includes game type information relating to past games played by the player and points awarded at the past games and the like. The points are awarded according to the game execution amount such as the consumed credits or the number of played games. For example, if 100 coins have been consumed or if 100 games have been played, one point is awarded.

Then, the controller 40 sets the game of default game software (game A) and the game of permitted game software as selectable (step S204). The game permitted software will be described below.

Thereafter, the controller 40 determines whether or not the points have reached a minimum preset value (e.g., 50 points) based on the gaming history data (step 205). If it is determined that the points have not reached the minimum preset value, the controller 40 does not set selectable games any more. That is, the player may play only the game of the default game software (game A) and the game of the permitted game software.

On the other hand, if it is determined that the points have reached the minimum preset value, the controller 40 sets the game of the base game software as selectable in addition to the games of the default game software and the permitted game software (step S206). On the game of the base game software, a high bet can not be bet. Therefore, the player can select the game of the default game software, the game of the permitted game software, or the game of the base game software.

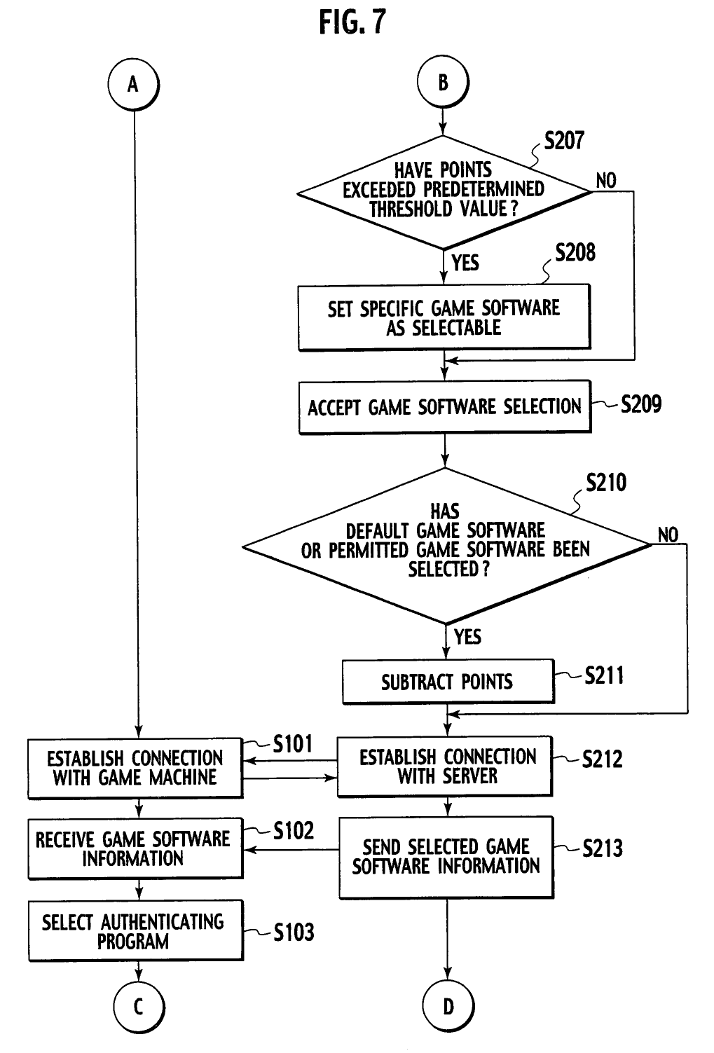

Furthermore, the controller 40 determines whether or not the points have reached a preset threshold value (e.g., 100 points) (step S207 in FIG. 7). If it is determined that the points have reached the threshold value, the controller 40 sets a game of the specific game software as selectable in addition to the games of the default game software, the permitted game software and the base game software (step S208). On the game of the specific game software, a high bet can be bet. Therefore, the player may select any one of the game of the default game software, the game of the permitted game software, the game of the base game software and the game of the specific game software. Here, “a high bet can be bet” means that the number of credits that can be bet on one game is highly set. In addition, the above-mentioned threshold value can be changed as appropriate by the operation of a system administrator.

Then, the controller 40 enables the operation of the touch screen 69, allowing selection of the game software via the touch screen 69 (step S209). That is, it makes a state that the player can select the desired game by touching the touch screen 69. The touch screen 69 corresponds to the selection switch in the present invention. However, the selection switch in the present invention, not limited to this example, may be various input buttons 23, a key pad 38, and the like, alternatively, may be separately provided.

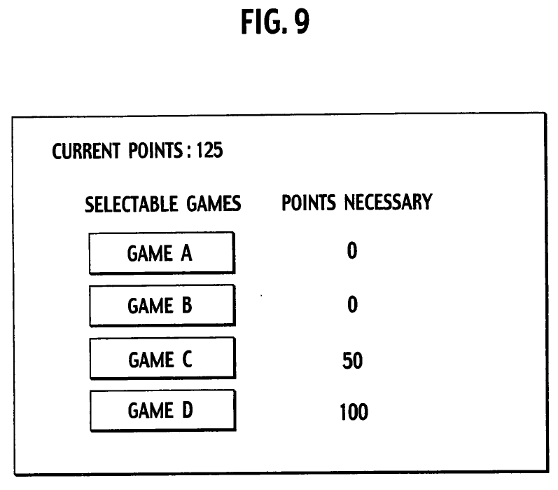

FIG. 9 is an explanatory diagram showing an image when selectable games are displayed on the lower display 16 of the slot machine. As shown in FIG. 9, it is displayed at the top of the lower display 16 that current points are 125.

Additionally, a default game A, a permitted game B, a base game C and a specific game D are displayed on the center of the lower display 16. Numbers of points required to select and play each game of A to D are displayed to the right thereof. In this example, as the current points are 125 (“YES” in step S207 in FIG. 7), all of the games A to D may be selectable. Further, when the game is selected, the points required for this selection of the game are consumed. For example, if the game D is selected, 100 points are consumed and 25 points are left.

The controller 40 determines whether any of the default game and the permitted game has been selected or not (Step S210). Then, the controller 40 advances the process to step S212, when either of the default game or the permitted game has been selected. On the other hand, when neither of them has been selected (the base game or the specific game has been selected), the number of points according to the selected game is subtracted (step S211).

For example, 50 points are subtracted from the current points if the game C which is executed using the base game software has been selected. 100 points are subtracted from the current points if the game D which is executed using the specific game software has been selected. Further, as for the games using the base and specific game software, they may be selected without consuming the points if once they were selected. That is, the game software which was once selected is stored in the smart card as the permitted game software.

Afterwards, the controller 40 executes a process of downloading software to execute the selected game from the server, when the games B to D other than the default game A are selected. That is, first, the controller 40 establishes connection with the server 100 via the router 4 (step S212). Further, the processor 101 of the server 100 establishes connection with the game machine 10 (step S101).

The controller 40 of the game machine 10 sends the selected game software information to the server (step S213). The processor 101 in the server 100 receives the game software information sent from the game machine 10 (step S102), and selects an authenticating program relating to the game software (step S103). In the step S103, the processor 101 also bundles the selected authenticating program.

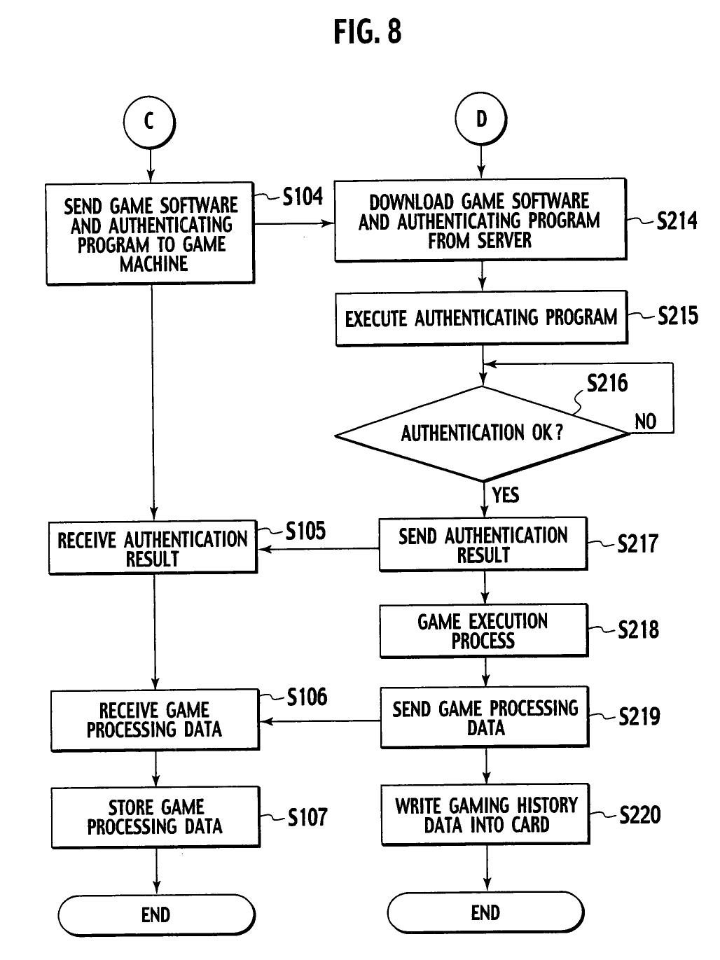

Then, the processor 101 sends the selected game software and the authenticating program of the game software to the game machine 10 (step S104 in FIG. 8).

The controller 40 of the game machine 10 downloads the selected game software and the authenticating program into the hard disk drive 43 from the server 100 (step S214). The controller 40 executes the downloaded authenticating program (step S215).

The authenticating program generates a hash value by executing hash function to the game software and compares it with a hash value stored in the authenticating program in advance. By this, presence of falsification is checked. If no falsification is found, it is authenticated as legitimate. If falsification is found, an error is generated.

The controller 40 sends the authentication result by executing the authenticating program to the server 100 (step S217). The server 100 receives the authentication result (step S105).

Thereafter, the controller 40 executes the game execution processing of the selected game (step S218). Thus, the player of the game machine 10 can execute the game selected by himself/herself. The concrete processing procedure of the game execution process will be described below.

After the game is played, the controller 40 sends game processing data to the server 100 (step S219), and writes gaming history data obtained as a result of the game processing into the smart card (step S220).

The processor 101 of the server 100 receives the game processing data (step S106). The game processing data includes the number of coins consumed, the number of times of games played and the points awarded during the game. These data are stored into a memory 102 as the gaming history, in association with the ID code (step S107). Then the process is completed.

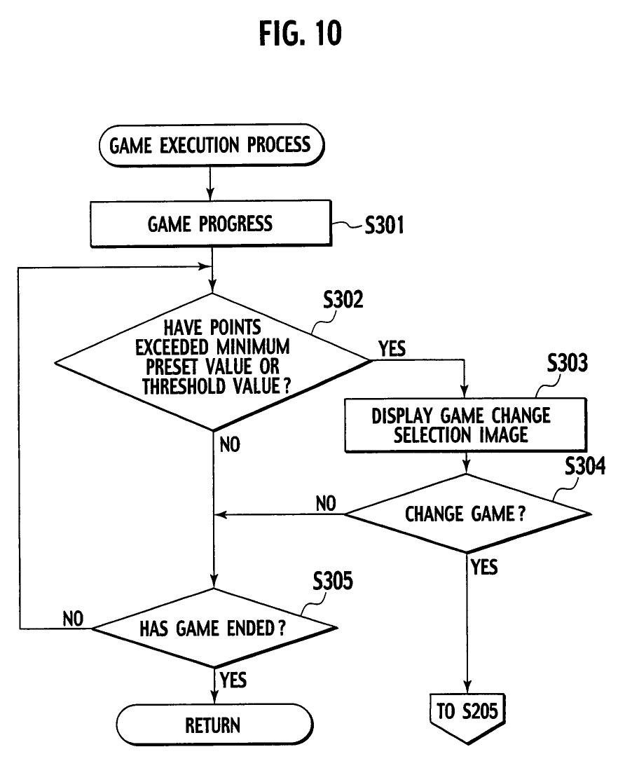

FIG. 10 is a flow chart illustrating the game execution processing in step S218 of FIG. 8. First, the controller 40 advances the game (step S301). In this process, the controller 40 awards points according to the game execution amount such as the number of coins inserted or number of times of games played.

Then, the controller 40 determines whether or not the points are more than the above-mentioned minimum preset value, or the threshold value when the points newly generated in the course of progress of the game are added (step S302). If it is determined that the points are more than the minimum preset value, or the threshold value, a selection image for changing the game is displayed (step S303).

That is, if the points do not reach the minimum preset value (e.g., 50), only the default game (game A) and the permitted game (game B) are selectable. However, when the points reach the minimum preset value as a result of the progress of the game, the base game (game C) becomes selectable. For this purpose, a selection image questioning the player whether or not to change the game is displayed.

Similarly, when the points do not reach the threshold value (e.g., 100), only the default game A, the permitted game B and the base game C are selectable. However, when the points reach the threshold value (e.g., 100) as a result of the progress of the game, the specific game D becomes selectable. For this purpose, the selection image questioning the player whether or not to change the game is displayed.

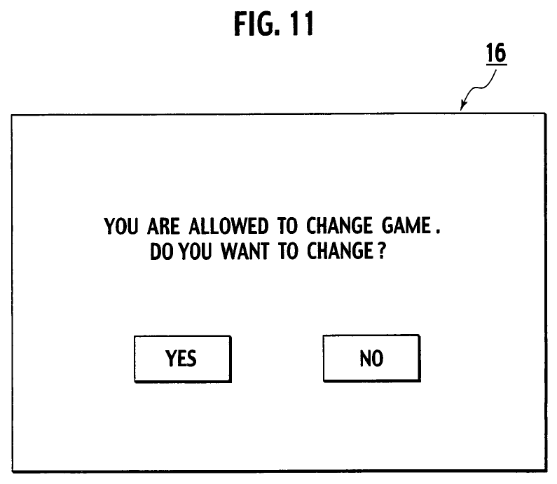

In this process, the controller 40 displays the image, for example, shown in FIG. 11 on the lower display 16, and accepts an input indicating whether or not to change the game. If there is an input requesting to change the game, an image similar to that in FIG. 9 is displayed. This allows the player to select a new game only by touching the touch screen 69.

FIG. 11 illustrates an image to be displayed on the lower display 16 of the slot machine. As shown in FIG. 11, a sentence such as “You are allowed to change the game. Do you want to change?” is displayed on the lower display 16. In addition, an image presenting “YES” and “NO” for selecting whether or not to change the game is displayed. The player can select whether or not to change the game by touching the touch screen 69.

Next, the controller 40 determines whether or not to change the game (step S304). In this process, the controller 40 determines whether or not a request to change the game has been input. If it is determined to change the game, the process returns to step S205 shown in FIG. 6.

If it is determined in step S302 that the points have not been more than the minimum preset value, or the threshold value, alternatively, if it is determined in step S304 not to change the game, the controller 40 determines whether or not to terminate the game (step S305). If it is determined not to terminate the game, the controller 40 returns the process to step S302. If, otherwise, it is determined to terminate the game, the controller 40 terminates this subroutine.

In this way, the player may select any of the selectable games according to the points to play the selected game.

Like this, in the game system according to the present embodiment, it is determined whether the specific game on which a high bet can be bet becomes selectable or not, according to the points awarded at past games played. That is, when the points are less than the threshold value, only the default game, the permitted game and the base game are set as selectable. However, when the points are more than the threshold value, the specific game becomes selectable in addition to the above-mentioned games.

Therefore, executing more games makes it possible to execute the game on which a high bet can be bet, which promotes the player's willingness to accumulate the points.

Further, as for the game that was once selected, the play is permitted without consuming the points thereafter, therefore, the points are not consumed by playing the past-played game.

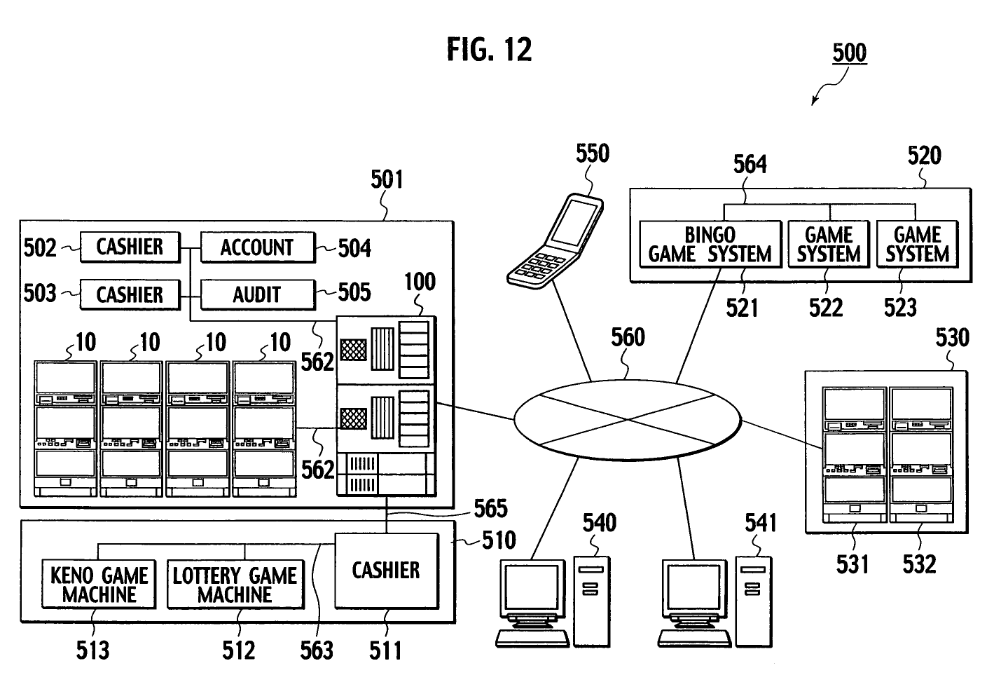

FIG. 12 is a schematic view illustrating a network of a game system according to another embodiment of the present invention. A game system 500 comprises a server 100. Further, the game system 500 comprises a slot machine 10, a lottery game machine 512, a keno game machine 513, a bingo game system 521, game systems 522, 523, video poker game machines 531, 532, personal computers 540, 541, and a cellular phone 550 as game machines.

The server 100 is installed in a casino 501. A plurality of slot machines 10, cashiers 502, 503, an account 504 and an audit 505 are connected to the server 100 through a LAN 562.

Further, the server 100 is connected to a cashier 511 installed in a restaurant 510 through an intranet 565. Further, the cashier 511 is connected to a lottery game machine 512 and a keno game machine 513 through a LAN 563.

In the present invention, the server 100 and each game machine may be connected through the intranet 565, in this way. Further, any other device (cashier 511) maybe interposed between the server 100 and the game machines.

Further, the server 100 is connected to a bingo game system 521 installed at another casino 520 through the Internet 560. The bingo game system 521 is connected to game machines 522, 523 for playing a bingo game through a LAN 564. Further, the server 100 is connected to a plurality of video poker game machines 531, 532 installed at the commercial facility 530 through the Internet 560.

Furthermore, the server 100 is connected to the personal computers 540, 541 and a cellular phone 550 through the Internet 560. Thus, in the present invention, the server 100 and the game machines may be connected through the Internet. In addition, personal belongings such as the personal computers 540, 541 and the cellular phone 550 may be game machines.

Moreover, in the above-mentioned embodiment, it is configured such that whether the specific game software on which a high bet can be bet is selectable or not is determined depending upon whether or not the points are more than the threshold value, by setting a threshold value of the points. However, it may be configured such that game software on which higher bet can be bet becomes selectable each time the points are more than the threshold value, by setting two or more threshold values.

Although embodiments of the present invention have been described as above, they are only presented as concrete examples, without particularly limiting the present invention. Concrete arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

In the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely explain the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of explanation. Additionally, although the processes in respective steps may be described using an expression common to human activities, the processes described in the present specification are executed, in principle, by a variety of devices. Furthermore, other arrangements required to execute respective steps are self-evident from the aforementioned description.

What is claimed is:

1. A game machine comprising:
a first memory for storing player's gaming history data including points awarded according to a past game execution amount;
a second memory for storing game software downloaded from a server storing multiple types of game software;
a player data reader for identifying a player; and
a controller operable to:
(a) based on the gaming history data of the player identified by the player data reader,
(i) make only base game software selectable for the player, when the points are not more than a preset threshold value, and
(ii) make specific game software on which a higher bet can be bet than that bet on the base game software selectable for the player, in addition to the base game software, when the points are more than the threshold value,
(b) download from the server game software selected by an external input by the player among selectable game software to store it in the second memory, and
(c) execute a game of the game software stored in the second memory.

2. The game machine according to claim 1, wherein
the controller is operable to make the game using the specific game software executable for the player irrespective of the points thereafter, when the points have been more than the threshold value, the game has been executed using the specific game software and the game execution amount using the specific game software has reached a predetermined amount.

3. The game machine according to claim 1, wherein
the controller is operable to accept an operation input by an administrator authorized to operate to change the threshold value.

4. A game machine comprising:
a card slot into which a card storing player's gaming history data can be inserted, the gaming history data including points awarded according to a past game execution amount and player's authenticating data;
a first memory for storing the gaming history data read from the card inserted into the card slot;
a second memory for storing game software downloaded from a server storing multiple types of game software;
a selection switch for selecting any game software from among the multiple types of game software;
a display for displaying an image relating to execution of the game software selected by the selection switch; and
a controller operable to:
(a) based on the gaming history data of the player stored in the first memory,
(i) make only base game software selectable for the player, when the points are not more than a preset threshold value, and
(ii) make specific game software on which a higher bet can be bet than that bet on the base game software selectable for the player, in addition to the base game software, when the points are more than the threshold value,
(b) download from the server game software selected by the player using the selection switch among selectable game software to store it in the second memory, and
(c) execute a game of the game software stored in the second memory.

5. The game machine according to claim 4, wherein
the controller is operable to make the game using the specific game software executable for the player irrespective of the points thereafter, when the points have been more than the threshold value, the game has been executed using the specific game software, and the game execution amount using the specific game software has reached a predetermined amount.

6. The game machine according to claim 4, wherein
the controller is operable to accept an operation input by an administrator authorized to operate to change the threshold value.

7. A game machine comprising:
a card slot into which a card storing player's gaming history data can be inserted, the gaming history data including points awarded according to a past game execution amount and player's authenticating data;
a first memory for storing the gaming history data read from the card inserted into the card slot;
a second memory for storing game software downloaded via a network interface from a server storing multiple types of game software;
a selection switch for selecting any game software from among the multiple types of game software;
a display for displaying an image relating to execution of the game software selected by the selection switch; and
a controller operable to:
(a) set predetermined game software as default game software to make it executable,
(b) based on the gaming history data of the player stored in the first memory,
(i) make base game software other than the default game software selectable for the player, when the points are not more than a preset threshold value, and
(ii) make specific game software on which a higher bet can be bet than that bet on the base game software selectable for the player, in addition to the base game software, when the points are more than the threshold value,
(c) download from the server game software selected by the player using the selection switch among selectable game software to store it in the second memory, and
(d) execute a game of the game software stored in the second memory,
wherein the controller is operable to subtract a predetermined number of the points from the gaming history data, when the specific game software or the base game software other than the default game software is selected.

8. The game machine according to claim 7, wherein
the controller is operable to make the game using the specific game software executable for the player irrespective of the points thereafter, when the points have been more than the threshold value, the game has been executed using the specific game software, and the game execution amount using the specific game software has reached a predetermined amount.

9. The game machine according to claim 7, wherein
the controller is operable to accept an operation input by an administrator authorized to operate to change the threshold value.

10. A game system comprising at least one game machine and a server; wherein
the game machine comprises:
a first memory which can store player's gaming history data including points awarded according to a game execution amount in the past;
a network interface for executing communication;
a second memory for storing game software downloaded from the server storing multiple types of game software;
a player data reader for identifying a player; and
a controller operable to:
(a) based on the gaming history data for the player identified by the player data reader,
(i) make only base game software selectable for the player, when the points are not more than a preset threshold value, and
(ii) make specific game software on which a higher bet can be bet than that bet on the base game software selectable for the player, in addition to the base game software, when the points are more than the threshold value,
(b) send to the server via the network interface a request signal of requesting to send game software selected by an external input by the player among selectable game software,
(c) download the game software received according to the request signal to store it in the second memory, and
(d) execute a game of the game software stored in the second memory, and wherein
the server is connected with the game machine via a network, comprises a third memory storing multiple types of the game software and sends the game software according to the request signal to the game machine when receiving the request signal via the network.

11. A game control method comprising:
identifying a player and recognizing the player's gaming history data which includes points awarded according to the past game execution amount;
making only base game software selectable for the player among multiple types of game software stored in a server, when the points are not more than a preset threshold value and making specific game software on which a higher bet can be bet than that bet on the base game software selectable for the player, in addition to the base game software, when the points are more than the threshold value, based on the gaming history data of the player; and
downloading from the server game software selected by an external input by the player among selectable game software to store it and executing a game of the game software.

12. The game control method according to claim 11 further comprising,
making the game using the specific game software executable for the player irrespective of the points thereafter, when the points have been more than the threshold value, the game has been executed using the specific game software and the game execution amount using the specific game software has reached a predetermined amount.

13. The game control method according to claim 11 further comprising,
accepting an operation input by an administrator authorized to operate to change the threshold value.

14. A game control method comprising:
recognizing player's gaming history data which includes points awarded according to the past game execution amount based on a card carried by the player;
making only base game software selectable for the player among multiple types of game software stored in a server, when the points are not more than a preset threshold value and making specific game software on which a higher bet can be bet than that bet on the base game software selectable for the player, in addition to the base game software, when the points are more than the threshold value, based on the gaming history data of the player;
accepting a selection input of the game software by the player using a selection switch; and
downloading from the server via a network interface the game software based on the selection input to store it and executing a game of the game software.

15. The game control method according to claim 14 further comprising,
making the game using the specific game software executable for the player irrespective of the points thereafter, when the points have been more than the threshold value, the game has been executed using the specific game software and the game execution amount using the specific game software has reached a predetermined amount.

16. The game control method according to claim 14 further comprising,
accepting an operation input by an administrator authorized to operate to change the threshold value.

17. A game control method comprising:
recognizing player's gaming history data stored in a card carried by the player when the card is inserted into a card slot, the gaming history data including points awarded according to a past game execution amount and player's authenticating data;
making predetermined game software set as default game software executable;
making base game software other than the default game software selectable for the player, when the points are not more than a preset threshold value and making specific game software on which a higher bet can be bet than that bet on the base game software selectable for the player, in addition to the base game software, when the points are more than the threshold value, based on the gaming history data;
accepting a selection input of the game software by the player using a selection switch;
downloading from the server via a network interface the game software based on the selection input to store it and executing a game of the game software; and
subtracting a predetermined number of the points from the gaming history data when the specific game software or the base game software other than the default game software is selected by the selection input.

18. The game control method according to claim 17 further comprising,
making the game using the specific game software executable for the player irrespective of the points thereafter, when the points have been more than the threshold value, the game has been executed using the specific game software, and the game execution amount using the specific game software has reached a predetermined amount.

19. The game control method according to claim 17 further comprising,
accepting an operation input by an administrator authorized to operate to change the threshold value.
